(19) United States
(12) Patent Application Publication
(10) Pub. No.: US 2007/0260936 A1
(43) Pub. Date: Nov. 8, 2007

(54) Systems and methods for assigning identifiers to test results for devices within a group

(76) Inventors: Carli Connally, Fort Collins, CO (US); Rayan Lessman, Loveland, CO (US); Kristin N. Casterton, Fort Collins, CO (US)

Correspondence Address: VERIGY, 4700 INNOVATION WAY, BLDG D1, FORT COLLINS, CO, 80528, US

(21) Appl. No.: 11/404,144

(22) Filed: Apr. 13, 2006

(51) Int. Cl. G06F 11/00

(52) U.S. Cl. 714/45

(57) ABSTRACT

There are disclosed systems and methods for coordinating test results of devices within a group. In an embodiment, the system may include code to assign identifiers to test results of a first test execution, receive a user-specified beginning point, and assign identifiers to test results of a second test execution. Each device is assigned an identical identifier for the test results of the first test execution and for the test results of the second test execution. In an embodiment, the method may include assigning identifiers to test results of a first test execution; specifying a beginning point; and assigning identifiers to test results of a second test execution. Each one of the devices is assigned an identical identifier for the test results of the first execution and for the test results of the second test execution. Other embodiments are also disclosed.

### BACKGROUND

Generally, system on a chip (SOC) devices do not have bar codes or other physical attributes for unique identification. For testing groups of devices, a tester may allow the input of unique device identifiers (IDs) for each one of the individual results. For example, an automatic numbering system may be used during the testing devices within a lot. The system may assign a device ID of 1 to the first device in the lot. The subsequent device may be assigned a device ID of 2 by the system. Each subsequent device may be assigned a device ID of a predefined incremental value, such as 3 to N, in which N is the total number of tested devices.

A problem may occur in the middle of testing a group of devices. For example, a connection problem may occur on the tester. It may not be desirable to return to the first device and then test the entire lot of devices. The user may decide to start testing from a point of occurrence for the problem or from a point just prior to the occurrence of the problem. However, the user may also desire to have the results for the entire lot of devices reported in a single file. Also, the user may want to have the results of a second test procedure for the group (or partial group) correlate to the results of a first test procedure for the group (or partial group).

### SUMMARY OF THE INVENTION

In an embodiment, there is provided a system for coordinating test results for devices within a group, the system comprising code to assign identifiers to test results of a first test execution, each one of the identifiers corresponding to one of the devices; code to receive a user-specified one of the identifiers as a beginning point for performing a second test execution on a portion of the devices; and code to assign identifiers to test results of the second test execution, each one of the identifiers corresponding to one of the portion of the devices, wherein test results for corresponding devices in the first test execution and the second test execution are assigned like ones of the identifiers.

In another embodiment, there is provided a method of coordinating test results for devices within a group, the method comprising assigning identifiers to test results of a first test execution, each one of the identifiers corresponding to one of the devices; receiving a user-specified one of the identifiers as a beginning point for performing a second test execution on a portion of the devices; and assigning identifiers to test results of the second test execution, each one of the identifiers corresponding to one of the portion of the devices, wherein test results for corresponding devices in the first test execution and the second test execution are assigned like ones of the identifiers.

Other embodiments are also disclosed.

### BRIEF DESCRIPTION OF THE DRAWINGS

Illustrative embodiments of the invention are illustrated in the drawings, in which:

FIG. 1 is an exemplary table with one set of device identifiers assigned to test results of a first test execution for a group of devices and a different set of device identifiers assigned to test results of a second test execution for a subset of the group of devices;

FIG. 2 is an exemplary table with one set of device identifiers assigned to test results for a first test execution for a group of devices and a corresponding set of device identifiers assigned to test results of a second test execution for a subset of the group of devices that correlate to the identifiers of the first test execution;

FIG. 3 illustrates a group of devices on a wafer;

FIG. 4 illustrates groups of devices on several wafers in attachment to a cassette;

FIG. 5 illustrates a set of cassettes within a magazine;

FIG. 6 illustrates a lot of wafers, with each one of the wafers having devices mounted thereon;

FIG. 7 illustrates an exemplary system for assigning identifiers to test results for devices within a group;

FIG. 8 is an exemplary table with one set of device identifiers assigned to test results of a first test execution for a group of devices and a corresponding set of device identifiers assigned to test results of a second test execution for a subset of the group of devices from a selected one of the devices as the starting point to a last one of the devices tested in the first test execution;

FIG. 9 illustrates an exemplary table with one set of device identifiers assigned to test results of a first test execution for a group of devices and a corresponding set of device identifiers assigned to test results of a second test execution for a subset of the group of devices from a selected one of the devices as the starting point to a selected one of the devices as the ending point; and

FIG. 10 illustrates an exemplary method of assigning identifiers to test results for devices within a group.

### DETAILED DESCRIPTION OF AN EMBODIMENT

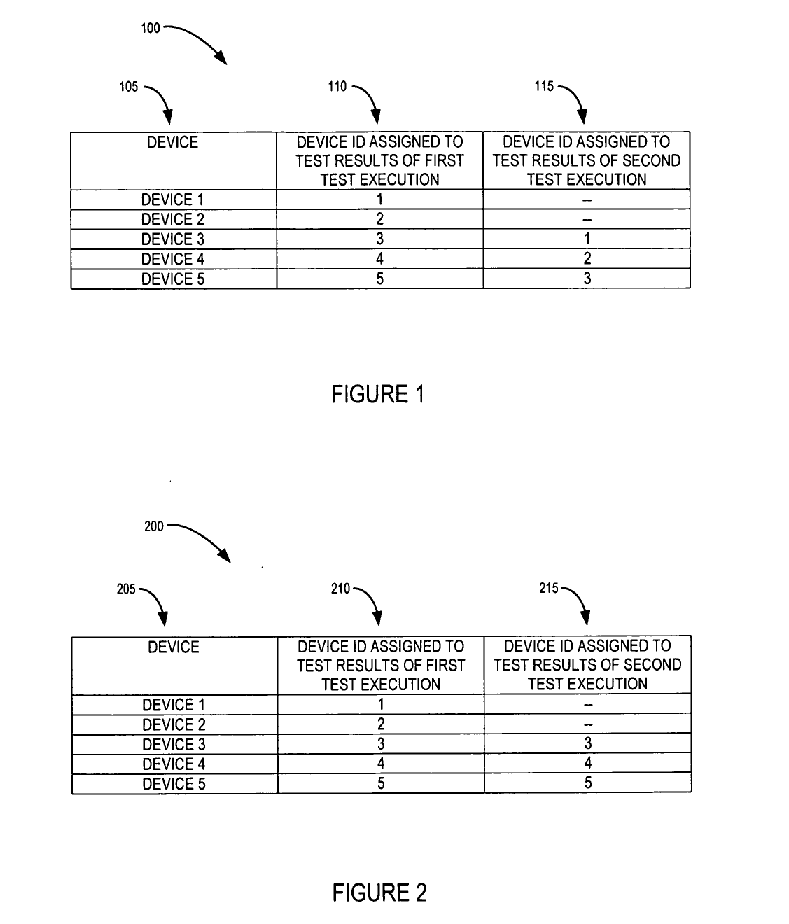

Referring to FIG. 1, there is shown a table 100 having a first column 105, a second column 110 and a third column 115. First column 105 identifies a series of devices in a group. Second column 110 identifies the device ID assigned to test results of a first test execution for the devices within the group. Third column 115 identifies the device ID assigned to test results of a second test execution for the tested devices within the group.

Typically, a test system will automatically number the devices from 1 to N when a user tests the lot of devices for the first time. For a retest of a portion of the devices in the lot, the system generally starts over to number the devices being tested from 1 to N. As shown in FIG. 1, the device identifier or ID for the first test execution and the device identifier or ID for a second test execution will not match one another if each of the test executions begin testing different devices.

In an embodiment, a user indicates to the system a starting point for assigning device identifiers, such as integers or other ID numbers. Referring to FIG. 2, there is shown a table 200 having a first column 205, a second column 210 and a third column 215. First column 205 identifies a series of devices within a group. Second column 210 identifies the device identifier or ID assigned to test results of a first test execution for the tested devices within the group. Third column 215 identifies the device identifier or ID assigned to test results of a second test execution for the tested devices within the group.

Referring still to FIG. 2, and in one embodiment, a user specifies “3” as the starting device identifier or ID for the second test execution to start at “DEVICE 3” (shown in column 205) so as to obtain results which correlate with first test execution. Accordingly, when a tester begins the second test execution on “DEVICE 3”, the test results are assigned identifier “3” and the subsequent test results for “DEVICE 4” and “DEVICE 5” are assigned identifiers “4” and “5”, respectively, so as to provide identifiers that correlate with one another for the first test execution and the second test execution.

It should be appreciated that a user may save a significant amount of time by only retesting part of a group. Furthermore, all test results for multiple test executions on a particular group of devices may be correlated and combined.

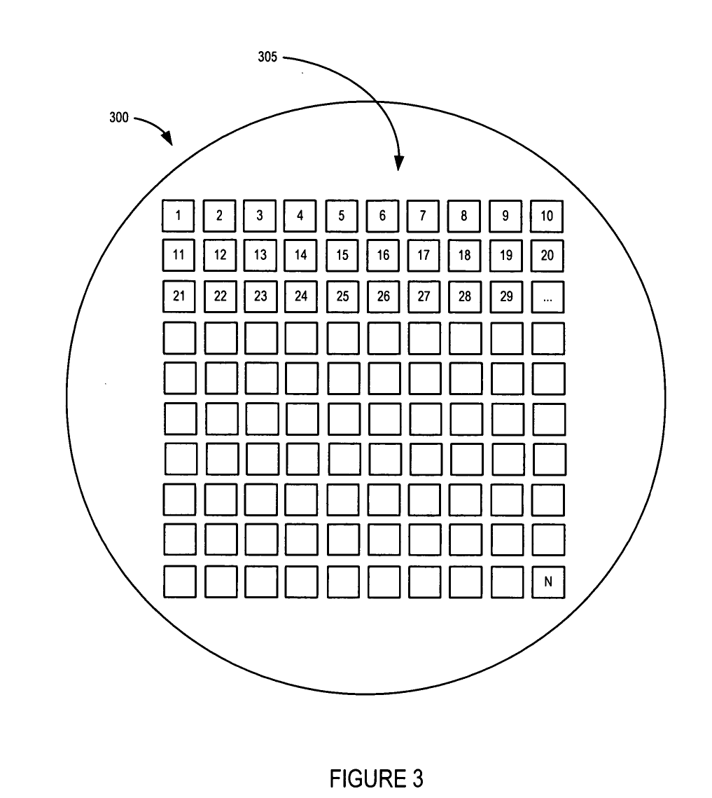

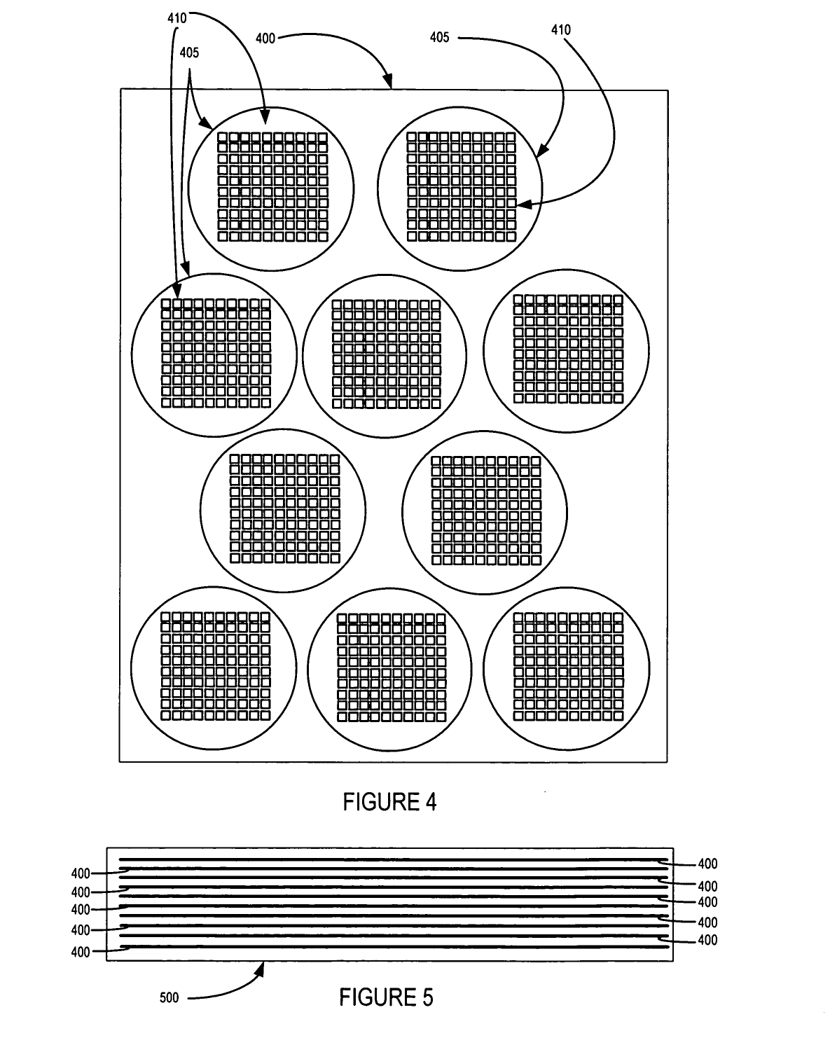

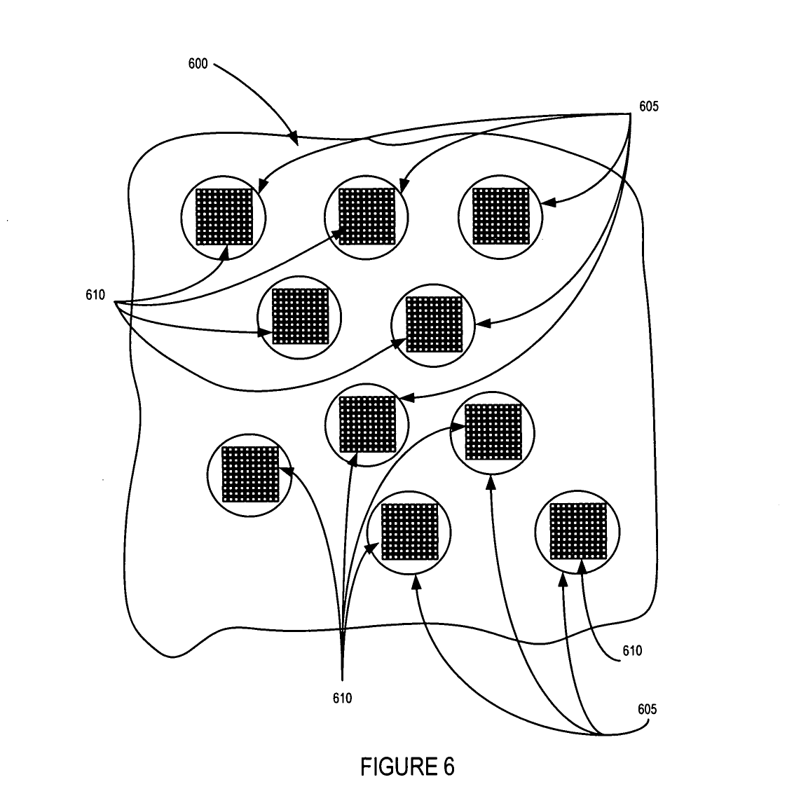

For example, the embodiments disclosed herein for systems and methods of testing devices may include, but are not limited to, testing a wafer 300 providing a group of N devices 305 (FIG. 3). The systems and methods of testing devices may include testing a cassette 400 having a group of wafers 405 providing a group of devices 410 (FIG. 4). The systems and methods of testing devices may include a magazine 500 having a group of cassettes 400 providing groups of wafers and groups of devices (FIG. 5). The systems and methods of testing devices may include a lot 600 having a group of wafers 605 proving groups of devices 610 (FIG. 6).

In an embodiment, there is provided a system 700 for coordinating test results for devices within a group. System 700 may include code 705 for performing a first test execution on devices. System 700 may also include code 710 for assigning identifiers to test results of the first test execution, each one of the identifiers corresponding to one of the devices. System 700 may further include code 715 for allowing a user to specify one of the identifiers as a beginning point for performing a second test execution on a portion of the devices. System 700 may include code 720 for performing the second test execution starting at the one of the devices corresponding to the one of the identifiers specified as the beginning point. System 700 may include code 725 for assigning identifiers to test results of the second test execution, each one of the identifiers corresponding to one of the portion of the devices, wherein each one of the devices is assigned an identical identifier for the test results of the first test execution and for the test results of the second test execution.

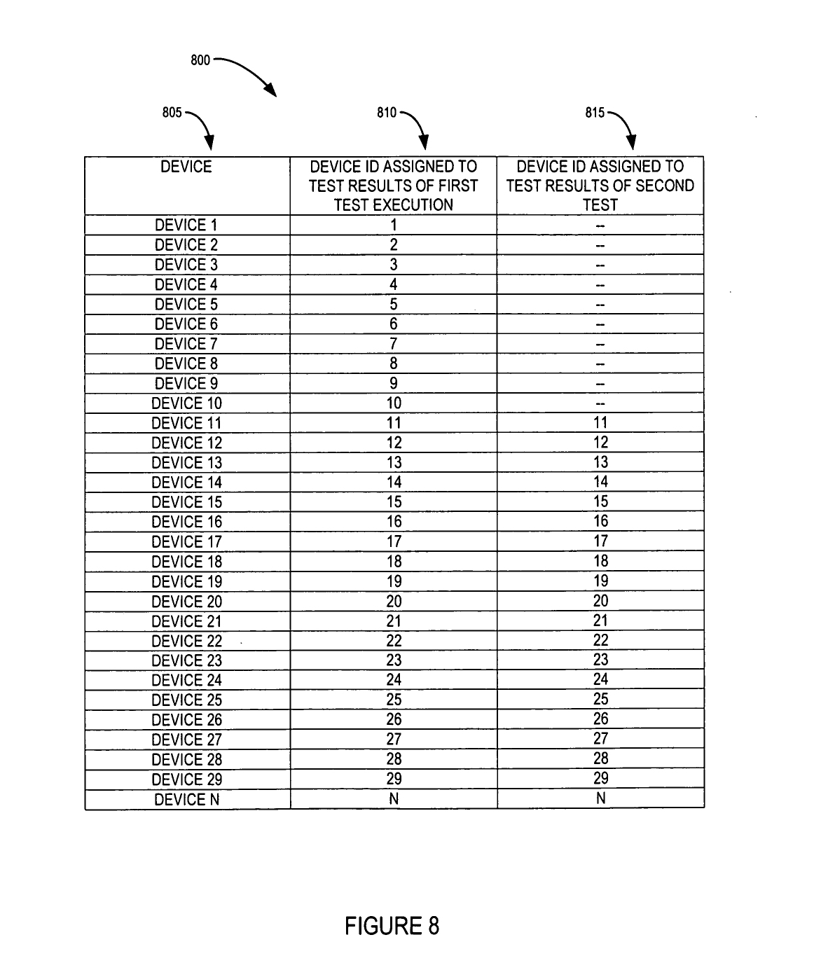

As shown in table 800 of FIG. 8, column 805 may represent a group of N devices under test by system 700. As discussed hereinabove, these devices may be provided as devices 305 on wafer 300 (FIG. 3). These devices may be provided as devices 410 on several wafers 405 in cassette 400 (FIG. 4). These devices may be provided as devices on groups of cassettes 400 within magazine 500 FIG. 5). These devices may be provided as devices 610 on several wafers 605 within lot 600 (FIG. 6). These devices may be provided in other groups of devices.

Looking still at FIG. 8, column 810 may be produced by code 705 for performing the first test execution on the devices, and by code 710 for assigning identifiers to the test results of the first test execution. Code 715 then allows a user to specify one of the identifiers, which in this example is device ID “11”, as the beginning point for performing the second test execution.

Looking again at FIG. 8, column 815 may be produced by code 720 for performing the second test execution, and by code 725 for assigning identifiers to the test results form the second test execution. As shown, the assigned device IDs for the second test execution correlate with the assigned device IDs for the first test execution.

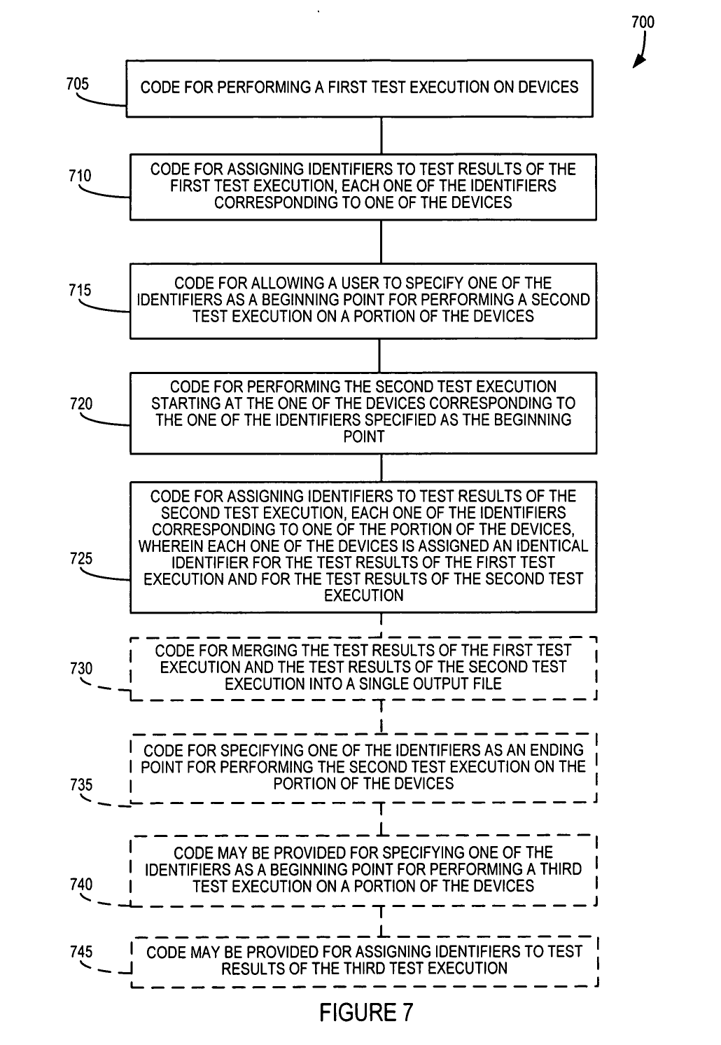

Referring to FIG. 7, and in one embodiment, system 700 may optionally include code 730 for merging the test results of the first test execution and the test results of the second test execution into a single output file. For example, the single output file may include, but is not limited to, an STDF (Standard Test Definition Format) file, an ASCII (American Standard Code for Information Interchange) file, an XML (extensible markup Language) file, and an EDL (Event Data Logging) file.

In one embodiment, code 705 for performing the first test execution on the devices, and the code 720 for performing the second test execution starting at the one of the devices corresponding to the one of the identifiers specified as the beginning point, may execute tests on the devices using automatic test equipment. The automatic test equipment may include, but is not limited to, an Agilent system or a Teradyne system.

In another embodiment, code 705 for performing the first test execution on the devices is executed on a first set of automatic test equipment, and code 720 for performing the second test execution on the devices is executed on a second set of automatic test equipment. In one embodiment, the first set of automatic test equipment and the second set of automatic test equipment may have distinct formats from one another. For example, and in an embodiment, an Agilent system may be either the first set of automatic test equipment or the second set of equipment. A Teradyne system may be the other set of automatic test equipment.

In an embodiment, code 710 for the assigning identifiers to the test results of the first execution assigns an integer to each one of the devices, starting the integer assignment at one, and increments the integer assignment by one for each subsequent assignment. In another embodiment, code 710 for assigning identifiers to the test results of the first test execution and the code 725 for assigning the identifiers to the second test execution includes assigns integers to the test results corresponding to the devices. Generally, code 710/725 for assigning integers to the test results corresponding to the devices increments the integers by one for each of the devices successively tested.

Alternatively, code 710/725 for assigning integers to the test results corresponding to the devices may increment the integers by a given multiple for each of the devices successively tested. For example, a given multiple of ten may be used such that the identifiers are assigned as 10, 20, 30, 40, and so on.

In another embodiment, each of the devices may be assigned a non-integer identifier. For example, the non-integer identifier may include alphanumeric identifiers such as abc1, abc2, abc3 . . . abcN.

In one embodiment, code 735 may optionally be provided for specifying one of the identifiers as an ending point for performing the second test execution on the portion of the devices.

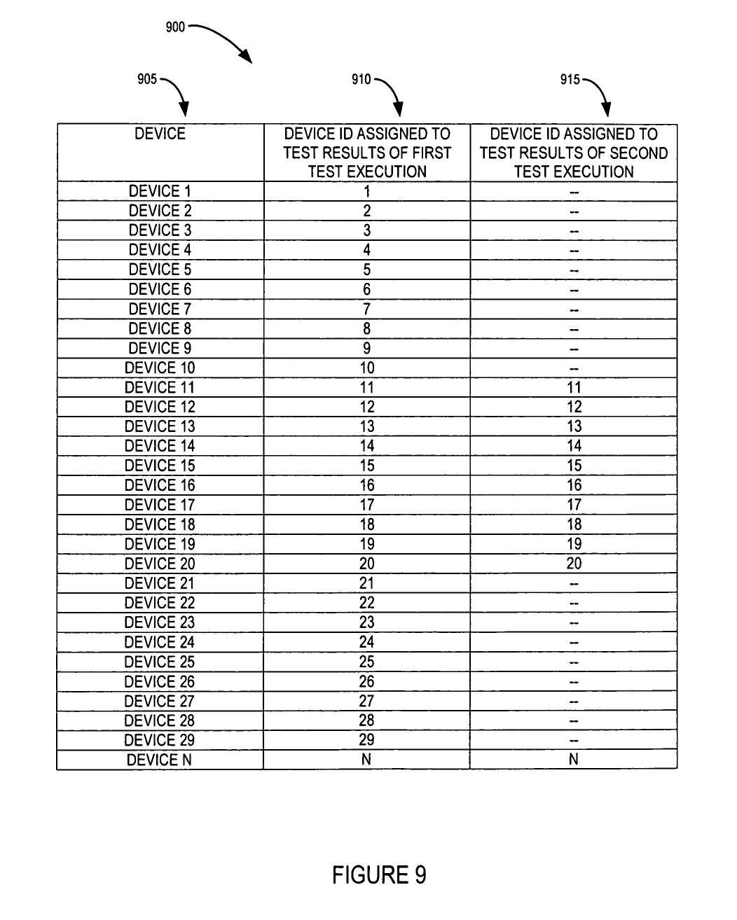

For example, and as shown in table 900 of FIG. 9, column 905 may represent a group of N devices under test by system 700. As discussed hereinabove, these devices may be provided as devices 305 on wafer 300 (FIG. 3). These devices may be provided as devices 410 on several wafers 405 in cassette 400 (FIG. 4). These devices may be provided as devices on groups of cassettes 400 within magazine 500 FIG. 5). These devices may be provided as devices 610 on several wafers 605 within lot 600 (FIG. 6). These devices may be provided in other groups of devices.

Looking still at FIG. 9, column 910 may be produced by code 705 for performing the first test execution on the devices, and by code 710 for assigning identifiers to the test results of the first test execution. Code 715 then allows a user to specify one of the identifiers, which in this example is device ID “11”, as the beginning point for performing the second test execution. Code 735 allows a user to specify one of the identifiers, which in this example is device ID 20, as the ending point for performing the second test execution on the portion of the devices.

Looking again to FIG. 9, column 915 may be produced by code 720 for performing the second test execution, and by code 725 for assigning identifiers to the test results form the second test execution. As shown, the assigned device IDs for the second test execution correlate with the assigned device IDs for the first test execution.

As discussed hereinabove, code 705 and code 710 may perform test executions on groups of devices. For example, code 705 may be provided for performing the first test execution and code 720 may be provided for performing the second test execution on devices contained on a wafer. Code 705 may be provided for performing the first test execution and code 715 may be provided for performing the second test execution on devices contained within a lot. Code 705 may be provided for performing the first test execution and code 720 may be provided for performing the second test execution on devices contained on a plurality of wafers within the lot.

Code 705 may be provided for performing the first test execution and code 720 may be provided for performing the second test execution on devices contained on a plurality of wafers contained on a cassette. Code 705 may be provided for performing the first test execution and code 720 may be provided for performing the second test execution on devices on a plurality of wafers on a plurality of cassettes contained in a magazine.

Code 705 may be provided for performing the first test execution and code 720 may be provided for performing the second test execution on devices having no identifying indicia thereon. For example, devices used in research and development projects often possess no identifying indicia.

In an embodiment, code 710/725 for assigning the identifiers to the test results of the first test execution may create identifiers corresponding to physical indicia which may be present on the devices. Code 705/720 for performing the first test execution and performing the second test execution may be carried out by automatic test equipment unequipped to read physical indicia which may be present on the devices.

Referring to FIG. 7, and in another embodiment, code 740 may optionally be provided for specifying one of the identifiers as a beginning point for performing a third test execution on a portion of the devices. Code 740 for performing the third test execution starts at the device corresponding to the identifier specified as the beginning point. Code 745 may optionally be provided for assigning identifiers to test results of the third test execution. Each one of the identifiers corresponds to one of the devices. Each one of the devices is assigned an identical identifier for the test results of the first test execution, for the test results of the second test execution, and for the test results of the third test execution.

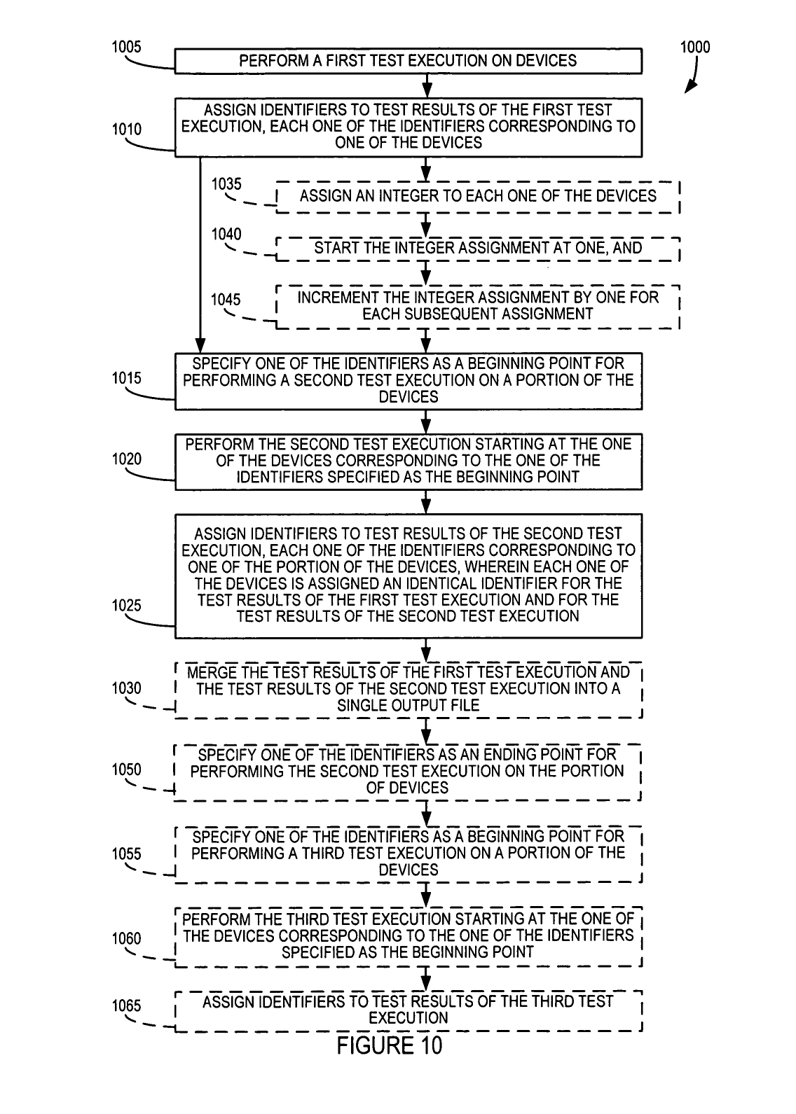

Looking now at FIG. 10, there is shown a method 1000 of coordinating test results for devices within a group. In an embodiment, method 1000 may include performing 1005 a first test execution on devices. Method 1000 may include assigning 1010 identifiers to test results of the first test execution, each one of the identifiers corresponding to one of the devices. Method 1000 may include specifying 1015 one of the identifiers as a beginning point for performing a second test execution on a portion of the devices. Method 1000 may include performing 1020 the second test execution starting at the one of the devices corresponding to the one of the identifiers specified as the beginning point. Method 1000 may include assigning 1025 identifiers to test results of the second test execution, each one of the identifiers corresponding to one of the portion of the devices, wherein each one of the devices is assigned an identical identifier for the test results of the first test execution and for the test results of the second test execution.

Optionally, the performing 1005 the first test execution and the performing 1020 the second test execution may each be carried out by automatic test equipment. For example, performing 1005 the first test execution and performing 1020 the second test execution may each be carried out by an Agilent system or a Teradyne system.

The performing 1005 the first test execution may be carried out by a first set of automatic test equipment and the performing 1020 the second test execution may be carried out by a second set of automatic test equipment. The first set of automatic test equipment and the second set of automatic test equipment may have distinct formats from one another. For example, either the first set of automatic test equipment or the second set of equipment may be an Agilent system. The other set of automatic test equipment may be a Teradyne system or another system not manufactured by Agilent. In another embodiment, both sets of automatic test equipment may be systems other than those manufactured by Agilent.

In another embodiment, method 1000 may optionally include the step of merging 1030 the test results of the first test execution and the test results of the second test execution into a single output file. The merging 1030 the test results of the first test execution and the test results of the second test execution into the single output file may create an STDF file, an ASCII file, an XML file, or an EDL file.

The assigning 1010 identifiers to the test results of the first execution may optionally include assigning 1035 an integer to each one of the devices, starting 1040 the integer assignment at one, and incrementing 1045 the integer assignment by one for each subsequent assignment.

The assigning 1010 the identifiers to the test results of the first test execution and assigning 1025 the identifiers to the test results of the second test execution may include assigning integers to the test results corresponding to the devices. Assigning 1035 the integers to the test results corresponding to the devices may include incrementing the integers by one for each of the devices successively tested.

In an embodiment, method 1000 may optionally include the step of specifying 1050 one of the identifiers as an ending point for performing the second test execution on the portion of the devices.

In an embodiment, the performing 1005 the first test execution and the performing 1020 the second test execution may each test the devices contained on a wafer. In another embodiment, the performing 1005 the first test execution and the performing 1020 the second test execution each may each test the devices contained within a lot. In one embodiment, the performing 1005 the first test execution and the performing 1020 the second test execution may test the devices contained on a plurality of wafers within the lot. In an embodiment, the performing 1005 the first test execution and performing 1020 the second test execution may each test the devices contained on a plurality of wafers contained on a cassette. In another embodiment, the performing 1005 the first test execution and performing 1020 the second test execution may each test the devices on a plurality of wafers on a plurality of cassettes contained in a magazine.

In one embodiment, the performing 1005 the first test execution and the performing 1020 the second test execution may each test the devices having no identifying indicia thereon. In another embodiment, the assigning 1005 the identifiers to the test results of the first test execution may create identifiers corresponding to physical indicia on the devices.

For some test situations, the performing 1005 the first test execution and performing 1020 the second test execution may be carried out by automatic test equipment unequipped to read physical indicia which may be present on the devices. For example, the specifying 1015 one of the identifiers the beginning point may be based on physical indicia which may be present on the devices and these physical indicia may be unreadable by automatic test equipment performing 1020 the second test execution.

In an embodiment, method 1000 may optionally include specifying 1055 one of the identifiers as a beginning point for performing a third test execution on a portion of the devices. Method 1000 may optionally include a step of performing 1060 the third test execution starting at the one of the devices corresponding to the one of the identifiers specified as the beginning point. Method 1000 may also optionally include assigning 1065 identifiers to test results of the third test execution. Generally, each one of the identifiers corresponds to one of the devices. Each device is assigned an identical identifier for the test results of the first test execution, the second test execution, and the third test execution.

What is claimed is:

1. A system for coordinating test results for devices within a group, the system comprising:
code to assign identifiers to test results of a first test execution, each one of the identifiers corresponding to one of the devices;
code to receive a user-specified one of the identifiers as a beginning point for performing a second test execution on a portion of the devices; and
code to assign identifiers to test results of the second test execution, each one of the identifiers corresponding to one of the portion of the devices, wherein test results for corresponding devices in the first test execution and the second test execution are assigned like ones of the identifiers.

2. A system in accordance with claim 1, further comprising code to perform a first test execution on a plurality of devices.

3. A system in accordance with claim 1, further comprising code to perform the second test execution starting at the one of the devices corresponding to the one of the identifiers specified as the beginning point.

4. A system in accordance with claim 1, further comprising code to merge at least some of the test results of the first test execution and at least some of the test results of the second test execution into a single output file.

5. A system in accordance with claim 2, wherein the single output file is one selected from the group consisting of an STDF file, an ASCII file, an XML file, and an EDL file.

6. A system in accordance with claim 1, further comprising code to perform the first test execution on the devices, and further comprising code to perform the second test execution starting at the one of the devices corresponding to the one of the identifiers specified as the beginning point, wherein the code to perform the first test execution and the code to perform the second test execution executes tests on the devices using automatic test equipment.

7. A system in accordance with claim 1, wherein the code to perform the first test execution on the devices is executed on a first set of automatic test equipment, and wherein the code for performing the second test execution on the devices is executed on a second set of automatic test equipment.

8. A system in accordance with claim 6, wherein the first set of automatic test equipment and the second set of automatic test equipment have distinct hardware formats from one another.

9. A system in accordance with claim 1, wherein the code to assign identifiers to the test results of the first test execution and the code to assign the identifiers to the test results of the second test execution assigns integers to the test results corresponding to the devices, and wherein the code to assign integers to the test results corresponding to the devices increments the integers by one for each of the devices successively tested.

10. A system in accordance with claim 1, further comprising code to specify one of the identifiers as an ending point for performing the second test execution on the portion of the devices.

11. A system in accordance with claim 1, wherein the code to perform the first test execution and the code to perform the second test execution each tests the devices contained on a semiconductor wafer.

12. A system in accordance with claim 1, wherein the code to perform the first test execution and the code for performing the second test execution each tests the devices contained within a lot.

13. A system in accordance with claim 1, wherein the code to assign the identifiers to the test results of the first test execution creates identifiers corresponding to physical indicia on the devices.

14. A system in accordance with claim 1, further comprising code to specify one of the identifiers as a beginning point for performing a third test execution on a portion of the devices, code to perform the third test execution starting at the one of the devices corresponding to the one of the identifiers specified as the beginning point, and code to assign identifiers to test results of the third test execution, wherein each one of the identifiers corresponds to one of the portion of the devices, and wherein each one of the devices is assigned an identical identifier for the test results of the first test execution, for the test results of the second test execution, and for the test results of the third test execution.

15. A method of coordinating test results for devices within a group, the method comprising:
assigning identifiers to test results of a first test execution, each one of the identifiers corresponding to one of the devices;
receiving a user-specified one of the identifiers as a beginning point for performing a second test execution on a portion of the devices; and
assigning identifiers to test results of the second test execution, each one of the identifiers corresponding to one of the portion of the devices, wherein test results for corresponding devices in the first test execution and the second test execution are assigned like ones of the identifiers.

16. A method in accordance with claim 15, further comprising performing the first test execution on a plurality of devices.

17. A method in accordance with claim 15, further comprising performing the second test execution starting at the one of the devices corresponding to the one of the identifiers specified as the beginning point.

18. A method in accordance with claim 15, wherein the performing the first test execution and performing the second test execution are each carried out by automatic test equipment.

19. A method in accordance with claim 15, wherein performing the first test execution is carried out by a first set of automatic test equipment and the performing the second test execution is carried out by a second set of automatic test equipment.

20. A method in accordance with claim 19, wherein the first set of automatic test equipment and the second set of automatic test equipment have distinct hardware formats from one another.

21. A method in accordance with claim 15, further comprising merging at least some of the test results of the first test execution and at least some of the test results of the second test execution into a single output file.

22. A method in accordance with claim 21, wherein the merging the at least some of the test results of the first test execution and the at least some of the test results of the second test execution into the single output file creates one selected from the group consisting of an STDF file, an ASCII file, an XML file, and an EDL file.

23. A method in accordance with claim 15, wherein the assigning identifiers to the test results of the first test execution and the assigning the identifiers to the test results of the second test execution includes assigning integers to the test results corresponding to the devices, and wherein the assigning integers to the test results corresponding to the devices includes incrementing the integers by one for each of the devices successively tested.

24. A method in accordance with claim 15, further comprising specifying one of the identifiers as an ending point for performing the second test execution on the portion of the devices.

25. A method in accordance with claim 15, wherein the performing the first test execution and the performing the second test execution each tests the devices contained on a semiconductor wafer.

26. A method in accordance with claim 15, wherein the performing the first test execution and the performing the second test execution each tests the devices contained within a lot.

27. A method in accordance with claim 15, wherein the assigning the identifiers to the test results of the first test execution creates identifiers corresponding to physical indicia on the devices.

28. A method in accordance with claim 15, wherein a user specifies the one of the identifiers as the beginning point based on physical indicia on the devices, wherein the physical indicia is unreadable by automatic test equipment performing the second test execution.

29. A method in accordance with claim 15, further comprising specifying one of the identifiers as a beginning point for performing a third test execution on a portion of the devices, performing the third test execution starting at the one of the devices corresponding to the one of the identifiers specified as the beginning point, and assigning identifiers to test results of the third test execution, each one of the identifiers corresponding to one of the portion of the devices, wherein each one of the devices is assigned an identical identifier for the test results of the first test execution, for the test results of the second test execution, and for the test results of the third test execution.
